(19) United States
(12) Patent Application Publication
(10) Pub. No.: US 2019/0065726 A1
(43) Pub. Date: Feb. 28, 2019

(54) SYSTEMS, METHODS AND DEVICES FOR SECURE INPUT PROCESSING

(71) Applicant: VeriFone, Inc., San Jose, CA (US)

(72) Inventors: Chris Anthony Madden, Dublin (IE); Manu Prasad Ramachandra Rao, Sunnyvale, CA (US)

(21) Appl. No.: 15/690,627

(22) Filed: Aug. 30, 2017

(51) Int. Cl. G06F 21/36

(52) U.S. Cl. CPC G06F 21/36; G06F 3/04883

(57) ABSTRACT

Systems, methods, and devices for secure input processing are disclosed. In one embodiment, a method for securely processing a touch-based gesture may include: (1) a first computer processor receiving a raw gesture data corresponding to a touch input; (2) the first computer processor communicating the raw gesture data and a fake gesture data as a transmission to a second computer processor; and (3) the first computer processor receiving a decoded transmission from the second computer processor comprising a decoded raw gesture data corresponding to the raw gesture data and a decoded fake gesture data corresponding to the fake gesture data.

### BACKGROUND OF THE INVENTION

### 1. Field of the Invention

The present disclosure relates generally to input processing, and, more particularly, to systems, methods, and devices for secure input processing.

### 2. Description of the Related Art

Point of sale (POS) and other transaction devices often include a touch-sensitive screen for interacting with customers. During a transaction, a customer may be requested to enter authenticating information, such as a personal identification number (PIN), using the touch-sensitive screen. Although the touch-sensitive screen is capable of receiving the digits of a PIN as gestures (e.g., digital handwriting), a significant amount of processing power is required to interpret the digital handwriting as digits. This is often more than the secure processor that is provided in the POS device.

These and other deficiencies exist.

### SUMMARY OF THE INVENTION

Systems, methods, and devices for secure input processing are disclosed. In one embodiment, a method for securely processing a touch-based gesture may include: (1) a first computer processor receiving a raw gesture data corresponding to a touch input; (2) the first computer processor communicating the raw gesture data and a fake gesture data as a transmission to a second computer processor; and (3) the first computer processor receiving a decoded transmission from the second computer processor comprising a decoded raw gesture data corresponding to the raw gesture data and a decoded fake gesture data corresponding to the fake gesture data.

In one embodiment, the method may further include the first computer processor identifying the decoded raw gesture data as an element of an authentication code.

In one embodiment, the decoded raw gesture data may include a digit, a character, etc.

In one embodiment, the step of the first computer processor communicating the raw gesture data and the fake gesture data as a transmission to a second computer processor may include the first computer processor selecting a position for the raw gesture data and a position for the fake gesture data in the transmission.

In one embodiment, the position for the raw gesture data and the position for the fake gesture data may be selected randomly, may be selected based on a prior position for at least one of the raw gesture data and the fake gesture data, etc.

In one embodiment, the fake gesture data may be based on a prior raw gesture data from a prior interaction.

In one embodiment, the method may further include the first computer processor associating the raw gesture data with an identifier.

In one embodiment, the method may further include the first computer processor identifying the decoded raw gesture data as corresponding to the raw gesture data. The first computer processor may identify the decoded raw gesture data as corresponding to the raw gesture data based on a position of the decoded raw gesture data in the decoded transmission, based on a position of the fake gesture data in the decoded transmission, etc.

According to another embodiment, a system for securely processing a touch-based gesture may include a terminal comprising a first computer processor and a second computer processor in communication with the first computer processor. The first computer processor may receive a raw gesture data corresponding to a touch input, communicate the raw gesture data and a fake gesture data as a transmission to a second computer processor, and receive a decoded transmission from the second computer processor comprising a decoded raw gesture data corresponding to the raw gesture data and a decoded fake gesture data corresponding to the fake gesture data.

In one embodiment, the raw gesture data may be received from a touch-sensitive input device.

In one embodiment, the first computer processor may identify the decoded raw gesture data as an element of an authentication code.

In one embodiment, the first computer processor may select a position for the raw gesture data and a position for the fake gesture data in the transmission. In one embodiment, the position for the raw gesture data and the position for the fake gesture data are selected randomly, may be based on a prior position for at least one of the raw gesture data and the fake gesture data, etc.

In one embodiment, the fake gesture data may be based on a prior raw gesture data from a prior interaction.

In one embodiment, the first computer processor may identify the decoded raw gesture data as corresponding to the raw gesture data. The decoded raw gesture data may be identified as corresponding to the raw gesture data based on a position of the decoded raw gesture data in the decoded transmission, based on a position of the fake gesture data in the decoded transmission, etc.

According to another embodiment, a method for securely processing a touch-based gesture may include: (1) a first computer processor receiving a plurality of raw gesture data, each corresponding to a touch input; (2) the first computer processor communicating the plurality of raw gesture data and a plurality of fake gesture data as a transmission to a second computer processor; and (3) the first computer processor receiving a decoded transmission from the second computer processor comprising a plurality of decoded raw gesture data corresponding to the plurality of raw gesture data and a plurality of decoded fake gesture data corresponding to the plurality of fake gesture data.

In one embodiment, the method may further include the first computer processor identifying the each of the decoded plurality of raw gesture data as elements of an authentication code.

In one embodiment, at least one of the plurality of decoded raw gesture data may include a digit, a character, etc.

In one embodiment, the step of the first computer processor communicating the plurality of raw gesture data and the plurality of fake gesture data as a transmission to a second computer processor may include the first computer processor selecting a position for each of the plurality of raw gesture data and the plurality of fake gesture data in the transmission.

In one embodiment, the positions for the plurality of raw gesture data and the plurality of fake gesture data may be selected randomly, may be based on a prior raw gesture data from a prior interaction, etc.

In one embodiment, the method may further include the first computer processor identifying each of the plurality of decoded raw gesture data as corresponding to each of the plurality of raw gesture data. The first computer processor may identify each of the plurality of the decoded raw gesture data as corresponding to each of the plurality of the raw gesture data based on a position of each of the plurality of the decoded raw gesture data in the decoded transmission.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a block diagram of a device for secure input processing according to one embodiment;

FIG. 2 depicts a block diagram of a system for secure input processing according to one embodiment; and

FIG. 3 depicts a method for secure input processing according to one embodiment.

### DETAILED DESCRIPTION OF PREFERRED EMBODIMENTS

The following descriptions provide different configurations and features according to exemplary embodiments. While certain nomenclature and types of applications/hardware are described, other names and application/hardware usage is possible and the nomenclature provided is done so by way of non-limiting examples only. Further, while particular embodiments are described, it should be appreciated that the features and functions of each embodiment may be combined in any manner within the capability of one of ordinary skill in the art. The figures provide additional exemplary details regarding the present invention. It should also be appreciated that these exemplary embodiments are provided as non-limiting examples only.

Various exemplary methods are provided by way of example herein. These methods are exemplary as there are a variety of ways to carry out methods according to the present disclosure. The methods depicted and described can be executed or otherwise performed by one or a combination of various systems and modules. Each block shown in the methods may represent one or more processes, decisions, methods or subroutines carried out in the exemplary method, and these processes, decisions, methods or subroutines are not necessarily carried out in the specific order outlined in the methods, nor is each of them required.

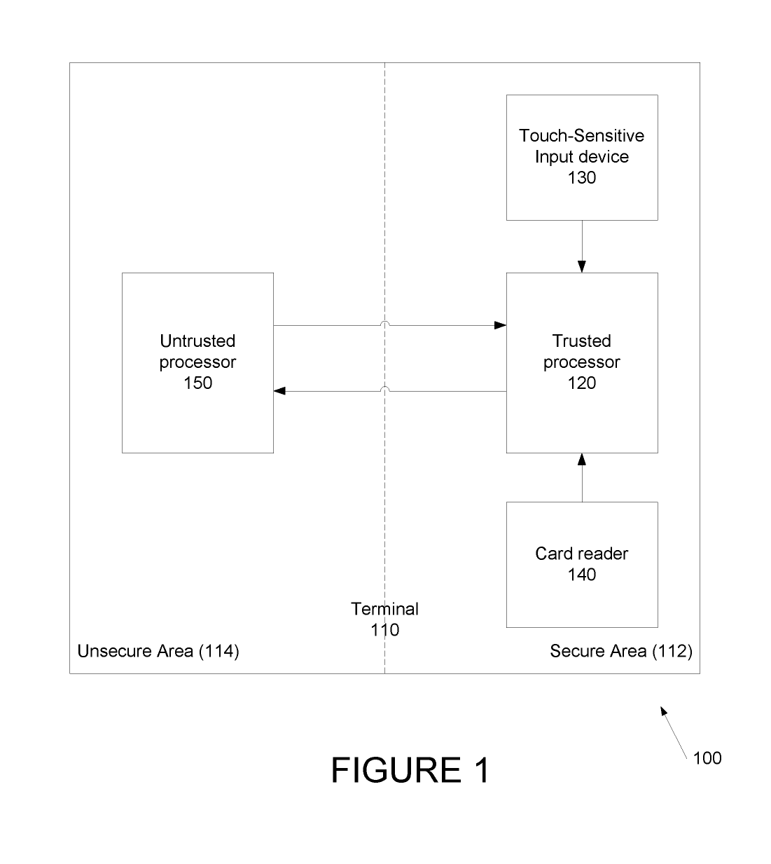

Several embodiments of the present invention and their advantages may be understood by referring to FIGS. 1-3.

While the embodiments disclosed herein may be made in the context of the entry of an authentication code that includes one or more digits, such as a PIN, it should be recognized that an authentication code may also include numbers, letters, characters, symbols, and/or any other suitable entry.

Referring to FIG. 1, a device for secure input processing is disclosed according to one embodiment. Device 100 may include terminal 110, which may be a point of sale device, a kiosk, an ATM, a gas pump, etc. In one embodiment, device 110 may include trusted processor 120, touch-sensitive input device 130, card reader 140, which may be a magnetic stripe reader and/or an EMV card reader, and untrusted processor 150.

In one embodiment, touch-sensitive input device 130 may be a touch-sensitive pad, screen, or display, and may receive an authentication code that is entered by a user using a stylus, the user's finger, etc.

In one embodiment, trusted processor 120 may process sensitive information, such as account numbers, personal identification numbers, etc. Untrusted processor 150 may process unsecure information, such as advertisements, loyalty program offers, inventory tracking, etc.

In one embodiment, trusted processor 120, touch-sensitive input device 130, and card reader 140 may be located within secure area 112 of terminal 110. In one embodiment, secure area 112 may be physically secured using materials (e.g., metals, tamper-resistant materials, tamper-evident materials, etc.) and/or it may be electrically secured.

In one embodiment, untrusted processor 150 may be located in unsecure area 114 of terminal 110. In one embodiment, unsecure area 114 may simply be an area of terminal 110 that does not have some or all of the physical and/or electrical security provided in secure area 112. In another embodiment, untrusted processor 150 may be located remotely from terminal 110, such as in a physically separate device, at a network location, in the cloud, etc.

In one embodiment, both trusted processor 120 and untrusted processor 150 may be located in secure area 112 of terminal 110.

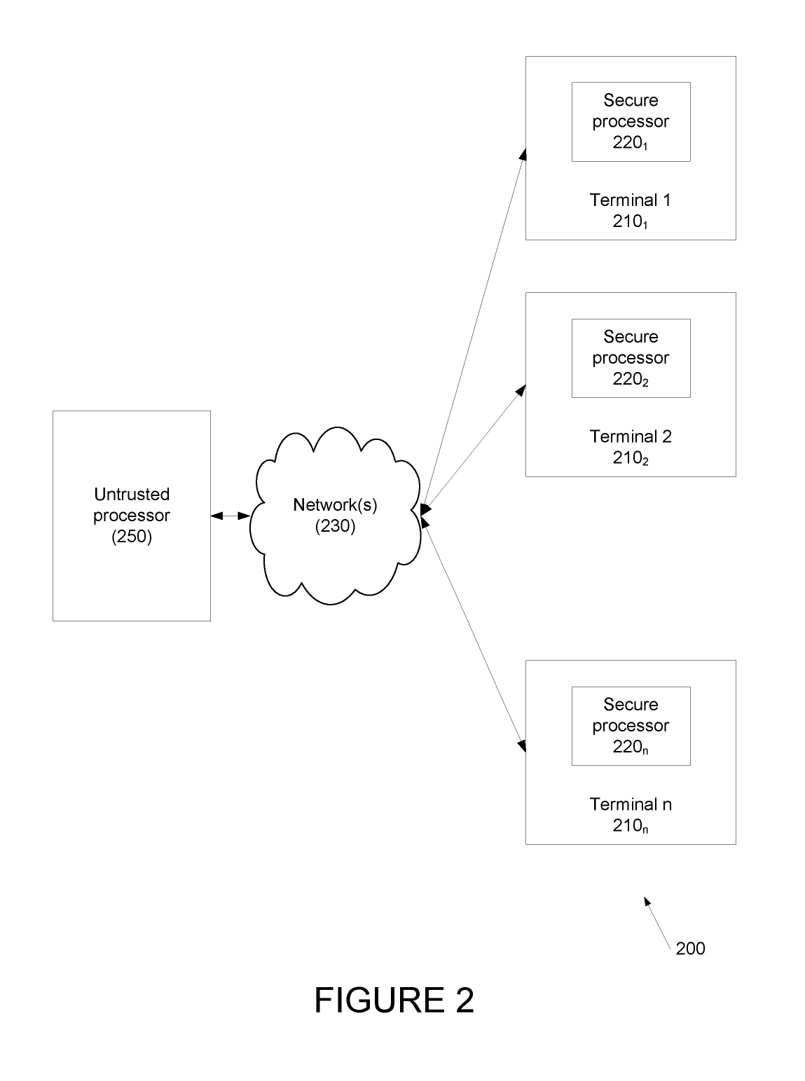

In one embodiment, an untrusted processor may communicate with a plurality of terminals. For example, referring to FIG. 2, a system for secure input processing is disclosed according to one embodiment. System 200 may include a plurality of terminals (e.g., 210₁, 210₂, . . . 210ₙ) each having a secure processor (e.g., 220₁, 220₂, . . . 220ₙ). The plurality of terminals may communicate with untrusted processor 250 over one or more network 230, including any suitable communication networks, payment networks, etc.

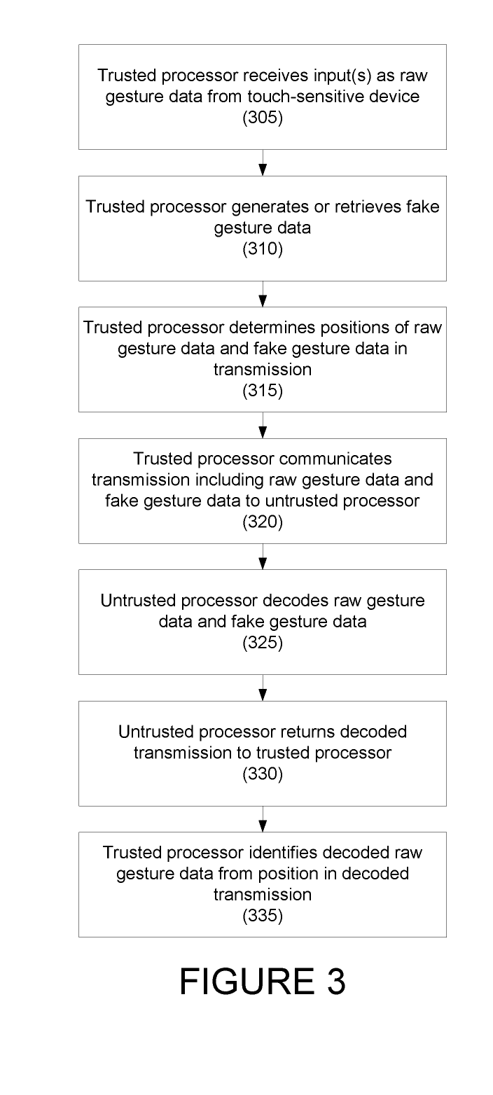

Referring to FIG. 3, a method for secure input processing is disclosed according to one embodiment.

In step 305, a trusted processor at a terminal (e.g., point of sale device, kiosk, ATM, gas pump, etc.) may receive one or more inputs (e.g., a number, a letter, a character, a symbol, etc.) as raw gesture data. For example, each input may be received as touch-based gesture on a touch-sensitive device using, for example, a stylus, a finger, a fingernail, etc. In one embodiment, the raw gesture data may include data representing, identifying, or indicating the pixels activated or traversed (i.e., the pixels that sensed a touch) during the gesture. The amount of raw gesture data received may depend on the screen sensitivity, such as the pixel density, the width of the gesture, etc.

In one embodiment, the gesture data may be received as a series of X and Y coordinates.

In one embodiment, the raw gesture data may further include pressure data related to the pressure at which the pixel was touched, activated or traversed.

In one embodiment, if there are multiple inputs, the inputs may be received and processed individually (e.g., as each input is processed as it is received), as subsets (e.g., two of four inputs are processed together), or may be received and processed together (e.g., all inputs are processed together).

In step 310, the trusted processor may generate or retrieve fake gesture data for one or more fake inputs. In one embodiment, the fake gesture data may be based, for example, on raw gesture data received during one or more prior interactions. The raw gesture data from a prior user interaction may be used without modification, or it may be modified by an amount (e.g., a predetermined amount, a random amount, a pseudo-random amount, etc.) so that it varies with each use.

In another embodiment, the fake gesture data may be randomly generated.

In still another embodiment, the fake gesture data may be retrieved from a storage location which may be local (e.g., in memory of the terminal) or located remotely (e.g., in the cloud). The retrieved data may be used without modification, or it may be modified by an amount (e.g., a predetermined amount, a random amount, a pseudo-random amount, etc.) so that may vary with each use.

In one embodiment, after the fake gesture data is used a certain number of times, it may be discarded.

In step 315, the trusted processor may select a format for a transmission that will be communicated to the untrusted processor for decoding. For example, the format may vary by the amount of raw gesture data that is included in the transmission (e.g., raw gesture data may be sent one at a time, or may be sent in sets), the amount of fake gesture data that is included in the transmission, the ordering of the raw gesture data and the fake gesture data in the transmission, etc.

In one embodiment, the size of the transmission (e.g., the amount of raw gesture data and fake gesture data) may be fixed (e.g., a total of 8 positions) while the amount of raw gesture data and fake gesture data, and/or the positions within the transmission, may vary. Any suitable format for the transmission (e.g., size, amount of raw gesture data and/or fake gesture data, and positions of raw gesture data and fake gesture data within the transmission) may be used as is necessary and/or desired.

In one embodiment, one or more of the size of the transmission, the amount of raw gesture data and/or fake gesture data, and positions of raw gesture data and fake gesture data within the transmission may be randomly selected or determined. In another embodiment, one or more of the size of the transmission, the amount of raw gesture data and/or fake gesture data, and positions of raw gesture data and fake gesture data within the transmission may change periodically (e.g., change every 5 interactions, every hour, every day, etc.). In another embodiment, one or more of the size of the transmission, the amount of raw gesture data and/or fake gesture data, and positions of raw gesture data and fake gesture data within the transmission may be pseudo-random.

In one embodiment, the size of the transmission and/or the amount of raw gesture data and/or fake gesture data may vary between a minimum and maximum number.

Any other suitable method for selecting the size of the transmission, the amount of raw gesture data and/or fake gesture data, and positions of raw gesture data and fake gesture data within the transmission may be used as is necessary and/or desired.

For example, in a transmission of eight positions, the first position may include fake gesture data, the second position may include raw gesture data, the third position may include raw gesture data, the fourth position may include fake gesture data, the fifth position may include fake gesture data, the sixth position may include raw gesture data, the seventh position may include fake gesture data, and the eighth position may include raw gesture data. Note that this is illustrative only, and a greater/fewer number of positions in the transmission may be used, a greater/fewer number of fake gesture data may be included, a greater/fewer number of raw gesture data may be included, and the positions of the raw gesture data and the fake gesture data may vary as is necessary and/or desired.

In one embodiment, the order of the raw gesture data in the transmission may be different from the order in which the raw gesture data is received.

The trusted processor may maintain at least the position(s) of the raw gesture data in the transmission so that it can extract the decoded raw gesture data from the decoded transmission received from the untrusted processor when it is returned. In one embodiment, the trusted processor may store the position(s) of the raw gesture data in memory. In another embodiment, the trusted processor may include an identifier that may be returned when the raw gesture data and the fake gesture data is decoded so that it can identify the raw gesture data. In yet another embodiment, the trusted processor may tag or associate the raw gesture data with an identifier. Any other suitable method for identifying the decoded raw gesture data may be used as is necessary and/or desired.

The trusted processor may then generate a transmission and place the raw gesture data and the fake gesture data in the transmission based on the selected size of the transmission, the amount of raw gesture data and/or fake gesture data, and positions of raw gesture data and fake gesture data.

In step 320, the trusted processor may communicate the transmission including the raw gesture data and the fake gesture data to the untrusted processor for decoding. The untrusted processor does not know which positions in the transmission have raw gesture data or fake gesture data, and nothing in the transmission indicates which data is raw gesture data and which is fake gesture data.

In step 325, the untrusted processor may decode both the fake gesture data and the raw gesture data from the transmission. In one embodiment, the untrusted processor may decode the data in the transmission in a first in, first out, manner. Thus, the order of the data in the transmission may not change.

In step 330, the trusted processor may receive the decoded transmission. In one embodiment, the decoded transmission may include decoded raw gesture data and decoded fake gesture data.

In step 335, may identify the positions(s) corresponding to the raw gesture data. The decoded transmission may be reordered (if necessary) and some or all of the decoded raw gesture data may be used to authenticate the user and/or a transaction.

In one embodiment, the decoded fake gesture data may be ignored or discarded.

In one embodiment, if additional inputs are required, the process may be repeated.

In another embodiment, each input may be processed as it is received. For example, after a first input is received, the raw gesture data for the first input may be communicated to the untrusted processor in a transmission containing fake gesture data as discussed above. With each subsequent input, the process may be repeated.

In one embodiment, the raw gesture data may be stored to memory and may be used as, or as a basis for generating, fake gesture data in a subsequent interaction or as necessary and/or desired.

The disclosure of International Patent Application Publication No. WO 2017091558 A1 is hereby incorporated, by reference, in its entirety.

Although multiple embodiments are disclosed, it should be recognized that these embodiments are not exclusive to one another, and features of one embodiment may be applied to the others as is necessary and/or desired.

It will be appreciated by those skilled in the art that the various embodiments are not limited by what has been particularly shown and described hereinabove. Rather the scope of the various embodiments includes both combinations and sub-combinations of features described hereinabove and variations and modifications thereof which are not in the prior art. It should further be recognized that these various embodiments are not exclusive to each other.

It will be readily understood by those persons skilled in the art that the embodiments disclosed here are susceptible to broad utility and application. Many embodiments and adaptations other than those herein described, as well as many variations, modifications and equivalent arrangements, will be apparent from or reasonably suggested by the various embodiments and foregoing description thereof, without departing from the substance or scope of the above description.

Accordingly, while the various embodiments have been described here in detail in relation to exemplary embodiments, it is to be understood that this disclosure is only illustrative and exemplary and is made to provide an enabling disclosure. Accordingly, the foregoing disclosure is not intended to be construed or to limit the various embodiments or otherwise to exclude any other such embodiments, adaptations, variations, modifications or equivalent arrangements.

What is claimed is:

1. A method for securely processing a touch-based gesture, comprising:
a first computer processor receiving a raw gesture data corresponding to a touch input;
the first computer processor communicating the raw gesture data and a fake gesture data as a transmission to a second computer processor; and
the first computer processor receiving a decoded transmission from the second computer processor comprising a decoded raw gesture data corresponding to the raw gesture data and a decoded fake gesture data corresponding to the fake gesture data.

2. The method of claim 1, further comprising:
the first computer processor identifying the decoded raw gesture data as an element of an authentication code.

3. The method of claim 1, wherein the step of the first computer processor communicating the raw gesture data and the fake gesture data as a transmission to a second computer processor comprises:
the first computer processor selecting a position for the raw gesture data and a position for the fake gesture data in the transmission.

4. The method of claim 3, wherein the position for the raw gesture data and the position for the fake gesture data are selected randomly.

5. The method of claim 1, further comprising:
the first computer processor identifying the decoded raw gesture data as corresponding to the raw gesture data.

6. The method of claim 5, wherein the first computer processor identifies the decoded raw gesture data as corresponding to the raw gesture data based on a position of the decoded raw gesture data in the decoded transmission.

7. A system for securely processing a touch-based gesture, comprising:
a terminal comprising a first computer processor; and
a second computer processor in communication with the first computer processor;
wherein:
the first computer processor receives a raw gesture data corresponding to a touch input;
the first computer processor communicates the raw gesture data and a fake gesture data as a transmission to a second computer processor; and
the first computer processor receives a decoded transmission from the second computer processor comprising a decoded raw gesture data corresponding to the raw gesture data and a decoded fake gesture data corresponding to the fake gesture data.

8. The system of claim 7, wherein the raw gesture data is received from a touch-sensitive input device.

9. The system of claim 7, wherein the first computer processor identifies the decoded raw gesture data as an element of an authentication code.

10. The system of claim 7, wherein the first computer processor selects a position for the raw gesture data and a position for the fake gesture data in the transmission.

11. The system of claim 10, wherein the position for the raw gesture data and the position for the fake gesture data are selected randomly.

12. The system of claim 10, wherein the position for the raw gesture data and the position for the fake gesture data are selected based on a prior position for at least one of the raw gesture data and the fake gesture data.

13. The system of claim 7, wherein the first computer processor identifies the decoded raw gesture data as corresponding to the raw gesture data.

14. The system of claim 13, wherein the decoded raw gesture data is identified as corresponding to the raw gesture data based on a position of the decoded raw gesture data in the decoded transmission.

15. A method for securely processing a touch-based gesture, comprising:
a first computer processor receiving a plurality of raw gesture data, each corresponding to a touch input;
the first computer processor communicating the plurality of raw gesture data and a plurality of fake gesture data as a transmission to a second computer processor; and
the first computer processor receiving a decoded transmission from the second computer processor comprising a plurality of decoded raw gesture data corresponding to the plurality of raw gesture data and a plurality of decoded fake gesture data corresponding to the plurality of fake gesture data.

16. The method of claim 15, further comprising:
the first computer processor identifying the each of the decoded plurality of raw gesture data as elements of an authentication code.

17. The method of claim 15, wherein the step of the first computer processor communicating the plurality of raw gesture data and the plurality of fake gesture data as a transmission to a second computer processor comprises:
the first computer processor selecting a position for each of the plurality of raw gesture data and the plurality of fake gesture data in the transmission.

18. The method of claim 15, wherein the positions for the plurality of raw gesture data and the plurality of fake gesture data are selected randomly.

19. The method of claim 15, further comprising:
the first computer processor identifying each of the plurality of decoded raw gesture data as corresponding to each of the plurality of raw gesture data.

20. The method of claim 19, wherein the first computer processor identifies each of the plurality of the decoded raw gesture data as corresponding to each of the plurality of the raw gesture data based on a position of each of the plurality of the decoded raw gesture data in the decoded transmission.
